(19) United States
(12) Patent Application Publication
(10) Pub. No.: US 2025/0363475 A1
(43) Pub. Date: Nov. 27, 2025

(54) CARD-BASED TRANSACTION PROCESSING AND SETTLEMENT USING MULTIPLE ELECTRONIC PAYMENT CHANNELS

(71) Applicant: Mudflap, Inc., Palo Alto, CA (US)

(72) Inventors: Piers Rollinson, Henderson, NV (US); Peter O’Leary, San Francisco, CA (US); Seth Levy, Oakland, CA (US); Sharon Yapp, Campbell, CA (US)

(21) Appl. No.: 18/669,779

(22) Filed: May 21, 2024

(51) Int. Cl. G06Q 20/22; G06Q 20/20; G06Q 20/34; G06Q 20/40

(52) U.S. Cl. CPC G06Q 20/227; G06Q 20/20; G06Q 20/34; G06Q 20/403

(57) ABSTRACT

Electronic settlement of transaction can be provided using multiple payment channels. A first payment channel using a payment network for submission of transaction data through the payment network and for reimbursement of a merchant using the payment network. A second payment channel uses a network separate from the payment network, and is used for transferring funds between the merchant and an issuer, without using the payment network. The funds transferred using the second payment channel are provided for settlement of costs payable by the merchant for a portion of the transaction, to accommodate for a discount calculated and provided by the issuer to a purchaser involved in the transaction, on behalf of the merchant.

### BACKGROUND

Obtaining fuel (e.g., vehicle fuel, such as diesel fuel for long-haul truckers) from a fueling station using a payment card has historically been limited to Point-of-Sale (POS) driven pricing models that provide merchant/fuel stations with limited flexibility in modifying pricing models, and which provide fuel purchasers (vehicle drivers) with limited visibility into pricing. While rich data has been provided to fuel purchasers in certain contexts, fuel purchasers have been unable to use physical cards to complete transactions while retaining the benefits of rich, network available data and pricing. Fuel merchants are similarly limited, whereby existing physical card payment networks do not provide flexibility for merchants to provide and/or update pricing data except through POS-based systems.

A need exists for computing systems that are integrated with physical card payment networks that enable novel transaction processing capabilities that are not otherwise available via traditional payment models.

### BRIEF SUMMARY

Certain embodiments are directed to a multi payment channel electronic transaction settlement system comprising memory and one or more processors configured for: receiving, using the one or more processors, first transaction data transmitted from a merchant using a first payment channel of a payment network, wherein the first transaction data comprises a merchant identifier, a purchaser identifier, and a first transaction value for a transaction between the merchant and a purchaser; deducting, using the one or more processors, a second transaction value from an account identified by the purchaser identifier, wherein the second transaction value is less than the first transaction value; generating, using the one or more processors, cost data comprising an amount owed by the merchant to satisfy at least a portion of a difference between the second transaction value and the first transaction value; transmitting, through a second payment channel separate from the payment network, at least a portion of the cost data to the merchant; and causing transfer of funds through the second payment channel to settle the amount owed by the merchant.

In certain embodiments, receiving the first transaction data transmitted from the merchant and through the first payment channel further comprises causing transfer of funds using the first payment channel to the merchant. In various embodiments, the transfer of funds through the second payment channel comprises transferring funds having a value calculated based in part on the amount owed by the merchant. In certain embodiments, receiving the first transaction data comprises: receiving a transaction authorization request for a standard transaction value; verifying the account identified by the purchaser identifier can satisfy the standard transaction value; and transmitting, a transaction authorization to the merchant to enable the merchant to generate the first transaction data.

In certain embodiments, the transaction authorization request is received before the first transaction value is determined by the merchant. In various embodiments, at least a portion of the first transaction data is retrieved by a point-of-sale terminal at the merchant from a physical card. In various embodiments, the system further comprises configurations for determining the second transaction value at least in part by accessing a reference table providing a discount for a purchase between the merchant and the purchaser.

Certain embodiments are directed to a method for electronic transaction settlement using multiple payment channels, the method comprising: receiving, using one or more processors, first transaction data transmitted from a merchant using a first payment channel of a payment network, wherein the first transaction data comprises a merchant identifier, a purchaser identifier, and a first transaction value for a transaction between the merchant and a purchaser; deducting, using the one or more processors, a second transaction value from an account identified by the purchaser identifier, wherein the second transaction value is less than the first transaction value; generating, using the one or more processors, cost data comprising an amount owed by the merchant to satisfy at least a portion of a difference between the second transaction value and the first transaction value; transmitting, through a second payment channel separate from the payment network, at least a portion of the cost data to the merchant; and causing transfer of funds through the second payment channel to settle the amount owed by the merchant.

In certain embodiments, receiving the first transaction data transmitted from the merchant and through the first payment channel further comprises causing transfer of funds using the first payment channel to the merchant. In various embodiments, the transfer of funds through the second payment channel comprises transferring funds having a value calculated based in part on the amount owed by the merchant. In certain embodiments, receiving the first transaction data comprises: receiving a transaction authorization request for a standard transaction value; verifying the account identified by the purchaser identifier can satisfy the standard transaction value; and transmitting, a transaction authorization to the merchant to enable the merchant to generate the first transaction data.

In certain embodiments, the transaction authorization request is received before the first transaction value is determined by the merchant. In various embodiments, at least a portion of the first transaction data is retrieved by a point-of-sale terminal at the merchant from a physical card. In various embodiments, the method further comprises determining the second transaction value at least in part by accessing a reference table providing a discount for a purchase between the merchant and the purchaser.

Certain embodiments are directed to a computer program product comprising a non-transitory computer readable medium having computer program instructions stored therein, the computer program instructions, when executed by a processor, cause the processor to: receive first transaction data transmitted from a merchant using a first payment channel of a payment network, wherein the first transaction data comprises a merchant identifier, a purchaser identifier, and a first transaction value for a transaction between the merchant and a purchaser; deduct a second transaction value from an account identified by the purchaser identifier, wherein the second transaction value is less than the first transaction value; generate cost data comprising an amount owed by the merchant to satisfy at least a portion of a difference between the second transaction value and the first transaction value; transmit through a second payment channel separate from the payment network, at least a portion of the cost data to the merchant; and cause transfer of funds through the second payment channel to settle the amount owed by the merchant.

In various embodiments, receiving the first transaction data transmitted from the merchant and through the first payment channel further comprises causing transfer of funds using the first payment channel to the merchant. In certain embodiments, the transfer of funds through the second payment channel comprises transferring funds having a value calculated based in part on the amount owed by the merchant. In certain embodiments, receiving the first transaction data comprises: receiving a transaction authorization request for a standard transaction value; verifying the account identified by the purchaser identifier can satisfy the standard transaction value; and transmitting, a transaction authorization to the merchant to enable the merchant to generate the first transaction data.

In various embodiments, the transaction authorization request is received before the first transaction value is determined by the merchant. In certain embodiments, at least a portion of the first transaction data is retrieved by a point-of-sale terminal at the merchant from a physical card. In certain embodiments, the computer program instructions, when executed by a processor, cause the processor to additionally: determine the second transaction value at least in part by accessing a reference table providing a discount for a purchase between the merchant and the purchaser.

### BRIEF DESCRIPTION OF THE SEVERAL VIEWS OF THE DRAWINGS

Reference will now be made to the accompanying drawings, which are not necessarily drawn to scale, and wherein:

FIG. 1 shows a system environment according to certain embodiments;

FIG. 2 is a schematic of an example remote computing entity according to certain embodiments;

FIG. 3 is a schematic of an example merchant system according to certain embodiments;

FIG. 4 illustrates example data stores within a remote computing entity according to certain embodiments;

FIG. 5 shows an example process flow of communications between entities according to certain embodiments;

FIGS. 6A-6B collectively show an example flowchart of a method for settling transactions using multiple payment channels according to certain embodiments; and

FIG. 7 shows an example screenshot showing a ledger for an example merchant.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

As used herein, “fuel exchange” is a type of transaction that refers to an exchange of value between a merchant (specifically, a merchant embodied as a fuel exchange entity that sells fuel) and a purchaser for a fuel event. For example, a fuel exchange may include a transaction for purchase of an amount of fuel (e.g., diesel fuel) from a fuel entity to be provided to a fuel recipient, such as a vehicle driver, a long-haul trucker, and/or other purchaser, where the particular amount of fuel is associated with a fuel event comprising dispensing the fuel into a container and/or a vehicle of a purchaser. A fuel exchange (or any transaction) may be associated with an identifier, referred to as a fuel exchange identifier (or more generally, a transaction identifier), and metadata. Non-limiting examples of the metadata include timestamps, geolocation data, fuel type, fuel volume, identifiers for an associated merchant, purchaser, purchaser computing entity, payment network, and/or the like.

As used herein, “fuel event” refers to an instance in which an amount of fuel from a fuel entity is deposited into a vehicle or other container of a purchaser, or otherwise where an amount of fuel is sequestered from or reserved by the fuel entity on behalf of the purchaser. In one example, a fuel event includes a vehicle of a purchaser receiving an amount of diesel fuel from a fueling station that is associated with a merchant. In another example, a fuel event includes a purchaser, or agent of a fuel entity, dispensing an amount of fuel into a fuel container. A fuel event and/or fuel exchange may occur at a physical establishment associated with a merchant, such as a fuel depot, filling station, gas station, and/or the like. Additionally, or alternatively, a fuel event may occur at a first location and a fuel exchange may be initiated at a second location, which may be a physical location or a virtual location. A fuel event may be associated with one or more identifiers, referred to as fuel event identifiers, and metadata. Non-limiting examples of the metadata include timestamps, geolocation data associated with a location of the fuel event, fuel type, fuel exchange amount, fuel exchange ratio, identifiers for an associated merchant, purchaser, purchaser computing entity, and/or the like.

It should be understood that fuel types are not limited to diesel fuels. As used herein, fuels involved in a fuel event may encompass the non-limiting examples of diesel, biodiesel, unleaded gasoline, leaded gasoline, off-road rated diesel, off-road rated gasoline, ethanol, kerosene, propane, liquid hydrogen, fuel oil, and/or the like. For certain merchant/fuel stations capable of metering electricity as a fuel to be provided to a vehicle (or other electricity storage device), the embodiments discussed herein can be utilized for fuel exchange transactions for providing electrical power for storage in a vehicle or other storage device.

As used herein, a “fuel entity” refers to a type of merchant that is a provider of fuel. For example, a fuel entity may be a merchant, such as an owner and/or operator of a gas station. In another example, a fuel entity may be a wholesale supplier of fuel. In still another example, a fuel entity may be a third-party fuel broker. A fuel entity may be associated with one or more fueling locations at which fuel exchanges are initiated and/or fuel is provided to a purchaser. A fuel entity (or other merchant) may be associated with one or more identifiers, referred to as merchant identifiers and metadata. Non-limiting examples of the metadata include a location of the fuel entity, or fueling location associated therewith, data indicative of one or more instruments of exchange of a fuel entity (e.g., financial account numbers, routing numbers, etc.), legal name of a fuel entity, retail licensure data associated with the fuel entity, and/or the like. Similar metadata may be provided for other merchant types.

As used herein, “purchaser” (or “fuel recipient”) refers to any entity that enters into an exchange of value with a merchant, such as a fuel entity to obtain fuel. In one example, a purchaser may be an individual that obtains fuel for their vehicle from a filling station (e.g., the filling station being associated with a particular merchant/fuel entity). In another example, a purchaser may be a business or other organization that obtains or reserves fuel from a fuel depot or fuel supply network associated with a fuel entity. In some embodiments, a purchaser is associated with a purchaser computing entity. In various embodiments, the purchaser computing entity includes any computing device configured to communicate with the remote computing entity. For example, the purchaser computing entity may be a computing device configured to transmit fuel code request to and receive fuel codes from the remote computing entity.

### Computer Program Products, Methods, and Computing Entities

Embodiments of the present systems and methods for using multiple payment channels to settle a card-based transaction may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution). The terms software, computer program product, and similar words may be used herein interchangeably.

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile memory).

In one embodiment, a non-volatile computer-readable storage medium may include a floppy disk, flexible disk, hard disk, solid-state storage (SSS) (e.g., a solid state drive (SSD), solid state card (SSC), or solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-recordable (CD-R), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present techniques for fuel exchange authorization and optimization may also be implemented as methods, apparatus, systems, computing devices, computing entities, and/or the like. As such, embodiments of the present techniques for fuel exchange authorization and optimization may take the form of an apparatus, system, computing device, computing entity, and/or the like executing instructions stored on a computer-readable storage medium to perform certain steps or operations. Thus, embodiments of the present techniques for fuel exchange authorization and optimization may also take the form of an entirely hardware embodiment, an entirely computer program product embodiment, and/or an embodiment that comprises combination of computer program products and hardware performing certain steps or operations.

Embodiments are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

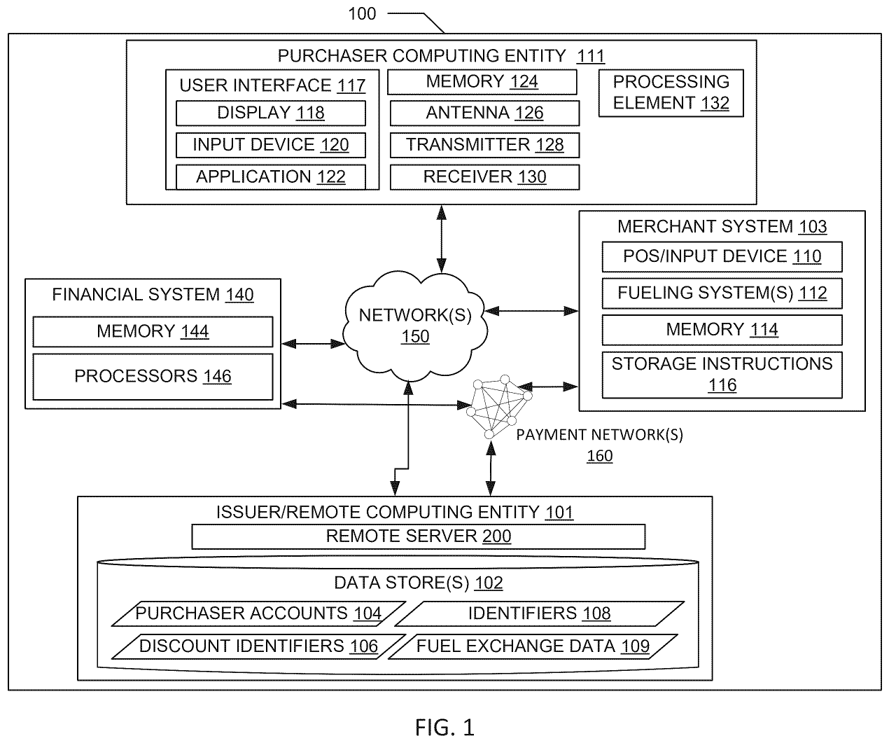

FIG. 1 is an illustration of an exemplary computer-based network environment for fund transfers using multiple (e.g., 2) payment channels for settling purchase transactions. Each payment channel passes through a different network (e.g., network 150 for one payment channel and network 160 for another payment channel). The embodiment shown in FIG. 1 is useful for settling fuel purchase transactions, which are characterized by payment challenges that present in transactions for goods/services of a known value, at least in part because the amount of the purchase is typically not known at the time that a pre-authorization is requested. As shown in FIG. 1, embodiments include a system environment 100 including a remote computing entity 101 (e.g., of a card issuer), one or more merchant systems 103 (as an example of a merchant system), one or more purchaser computing entities 111, and one or more financial systems 140. As shown, various of these entities can communicate with one another using networks 150, 160. Network 160 specifically represents a payment network for processing card-based transactions (e.g., credit card transactions, charge card transactions, debit card transactions, and/or the like). A first payment channel uses the payment network 160. Network 150 represents an communication network (and fund transfer network) that does not pass through the payment network 160. A second payment channel uses the network 150. As a specific example, payment network 160 may be managed by VISA®, whereas network 150 may exist separately from the payment network 160 (and may use an Automatic Clearing House (ACH) or other process for transferring funds between an account of the merchant and an account of the issuer). It should be understood that both networks 150, 160 may be operable at least partially via the Internet, but provide different access levels to different entities and have other characteristic differences such that transactions occurring using a second payment channel that uses one network (e.g., network 150) do not partially or wholly occur using the first payment channel that uses the other network (e.g., network 160). In certain embodiments, the payment network 160 may collect a fee for transactions using it, while transactions using network 150 (and therefore passing outside of payment network 160) are not subject to a fee.

Although not shown, a first Application Program Interface (API) enables communication between the merchant systems 103 and the payment network 160. A second API enables communication between the merchant systems 103 and network 150. A third API enables communication between the remote computing entity 101 and the payment network 160. A fourth API enables communication between the remote computing entity 101 and the network 150. A fifth API enables communication between the financial systems 140 and the payment network 160. A sixth API enables communication between the financial systems 140 and the network 150. A seventh API enables communication between the purchaser computing entity 111 and the network 150. The use of these APIs (or a subset thereof) is merely an example—other mechanisms enabling communication with and across networks 150, 160 between the illustrated entities and other entities may be usable in other embodiments.

In various embodiments, the remote computing entity 101 (e.g., of a card issuer and/or a third party sponsoring the card) includes one or more remote servers 200 configured to perform various functions and operations to pre-authorize, authorize, and/or settle purchase transactions such as fuel purchase transactions. The elements of the remote computing entity 101 may be provided via a plurality of computing devices that may be arranged, for example, in one or more server banks or computer banks or other arrangements. Such computing devices can be located in a single installation or may be distributed among many different geographical locations. For example, the remote computing entity 101 can include a plurality of computing devices that together may include a hosted computing resource, a grid computing resource, and/or any other distributed computing arrangement. In some cases, the remote computing entity 101 can correspond to an elastic computing resource where the allotted capacity of processing, network, storage, or other computing-related resources may vary over time.

In various embodiments, the remote computing entity 101 includes one or more data stores 102 configured to store various data that is accessible to the remote server 200 and/or the purchaser computing entity 111, and is used by the system environment 100 to execute various processes and functions discussed herein. The data store 102 can be representative of a plurality of data stores 102 as can be appreciated. The data store 102 can store data such as, but not limited to, purchaser accounts 104, discount identifiers 106, identifiers 108, and ledger data 109. In some embodiments, purchaser accounts 104, discount identifiers 106 together with corresponding discount indicators providing a value of a discount for one or more transactions, identifiers 108, and fuel exchange data (or subsets thereof) are stored in a memory of the purchaser computing entity 111.

In some embodiments, each purchaser account 104 is associated with a purchaser identifier data 501 and identifies a different purchaser and/or corresponding purchaser computing entity 111. The purchaser accounts 104 further comprise computing entity data 503 that associates a particular purchaser computing entity 111 with the purchaser account 104. The purchaser account 104 may additionally comprise credit information data 505 that provides an indication of an amount of credit available to the purchaser (if relevant). In some embodiments, the credit information data 505 may be modifiable by an administrator (that has access to the purchaser account 104 based on the inclusion of administrator data 506 within the purchaser account). The administrator may update/set credit information data 505 such as credit limits, limits on types of purchases, limits on the location of purchases, limits on the time of purchases, and/or the like. The credit information data 505 may, in some embodiments, comprise data identifying a financial account (or a financial institution) associated with the purchaser account 104. In some embodiments, the purchaser accounts include fuel code/discount data 508 that are associated with the purchaser accounts 104. As discussed in greater detail herein, discount data may be purchaser specific, in which case the discount data 508 is stored or referenced within the purchaser account 104. In some embodiments, discounts are merchant specific, in which case relevant discount data may be reflected in a merchant account, or within a listing of discount identifiers 106.

In some embodiments, the purchaser account 104 includes purchaser credentials for verifying an identity of a purchaser or purchaser computing entity 111. Non-limiting examples of purchaser credentials include username, password, biometric information (e.g., facial image, fingerprint scan, voice signature, and/or the like), cryptographic keys (e.g., public-private key pairs), legal name, age, birth date, internet protocol (IP) address, media access control (MAC) address, international mobile equipment identifier (IMEI) number, and/or the like. The purchaser account 104 may include other data associated with a purchaser, such as a payment card number (of payment instrument 625) and/or cryptographic keys for deciphering one-time use tokens that are used in place of payment card numbers during transactions, home address, driver's license number, commercial driver's license (CDL) number, employment status (e.g., independent contractor, self-employed, employee of a particular business, etc.), and/or contact information (e.g., phone number, email address, mailing address, social media accounts, and/or the like). The payment card number and/or cryptographic keys used to decipher single-use tokens may be used to identify a payment network 160 used for executing all or part of transactions using the payment card. It should be understood that purchaser accounts may store multiple payment instruments for the purchaser, including payment instruments that use different payment networks for transactions. In some embodiments, the purchaser account may additionally store information reflecting a financial institution and/or an account at a financial institution that is associated with the purchaser and/or the purchaser's payment instrument. In some embodiments, the purchaser account 104 may store credit information of the purchaser. The credit information comprises an indication of a credit limit for the purchaser (or a specific payment account associated with the purchaser), an indication of the amount of credit used by the purchaser (or a specific credit account associated with the purchaser), an indication of daily (or other period) credit limits, and/or the like. In some embodiments, the credit information may be set at least in part by an administrative user having access to credit settings for the purchaser account 104. For example, the credit information may be set to have an administrator-provided credit limit, an administrator-provided limit on the location(s) where a card may be used by the purchaser, product type(s) that may be purchased by the purchaser with the payment instrument 625, and/or the like. Portions of the credit information may be used during certain steps of processing a transaction, such as checking whether the purchaser's payment card (and associated account) has a sufficient credit limit to settle a transaction, or whether the purchaser's financial account has sufficient funds to settle the transaction.

In some embodiments, the purchaser account 104 includes data associated with one or more vehicles owned or operated by a purchaser, such as a vehicle registration number, license plate number, vehicle manufacturer, vehicle model, vehicle manufacture year, vehicle service record, vehicle emissions record, and/or the like. In some embodiments, the purchaser account 104 includes data associated with historical fuel events. For example, the purchaser account 104 may include historical transaction data, fuel exchange amounts, historical fueling locations, historical fuel volumes, and/or the like. In some embodiments, the purchaser account 104, or a subset thereof, is stored in an encrypted format. For example, personally identifiable information (PII) associated with a purchaser, or an associated vehicle, may be encrypted such that access thereto requires a dual-authentication process, authentication of a public-private key pair, and/or other security measure.

In some embodiments, discount identifiers 106 are stored within a look-up table that can be used by the remote computing entity 101 to determine an appropriate discount to be applied to a particular transaction. Discounts may be transaction specific and may be associated with a fuel code 517 or other unique discount identifier (e.g., a single-use token that is limited to use by a single purchaser, at a single merchant, for a limited period of time). In other embodiments, discounts may be merchant specific 513 and may be associated with discount identifiers 106 that are usable for any transaction with the merchant (these discount identifiers 106 may be stored in a merchant account or may reference the merchant account), purchaser specific 515 and may be associated with discount identifiers 106 that are usable for any transaction with the purchaser (these discount identifiers 106 may be stored in a purchaser account or may reference the purchaser account), and/or the like. In any embodiment, discount identifiers 106, along with discount data defining qualifications for using a particular discount, is stored in data store 102 in a look-up table enabling the remote computing entity 101 to determine an appropriate discount for a transaction, based on transaction data received through the payment network 160. The transaction data may be matched with portions of the discount data of a particular discount identifier 106 to identify the appropriate discount for application during a particular transaction. The type and/or amount of discount (e.g., percentage off, including the defined percentage, gross discount, including the defined gross discount amount, and/or the like) is stored as a part of the discount data, thereby enabling the remote computing entity 101 to apply the discount to a transaction. For example, the received transaction data includes a payment instrument identifier (e.g., a single-use payment instrument token, an encrypted payment instrument identifier, or other identifying data that may be used to identify a payment instrument and/or purchaser account associated with the payment instrument), a merchant identifier, a transaction identifier, and/or the like. Portions of the transaction data may be compared against the look-up table including the discount data to identify an appropriate discount to apply against the transaction. Where multiple matching discount identifiers are located within the look-up table, the remote computing entity 101 applies a stored criterion to identify the discount for use in the transaction (e.g., lowest overall price, lowest unit price, most-recent discount, and/or the like). The look-up table is dynamically updated in some embodiments (e.g., as discount identifiers 106 and associated discounts are generated, used, or expired, for example). Discounts may be provided as a percentage, a gross amount, or the like.

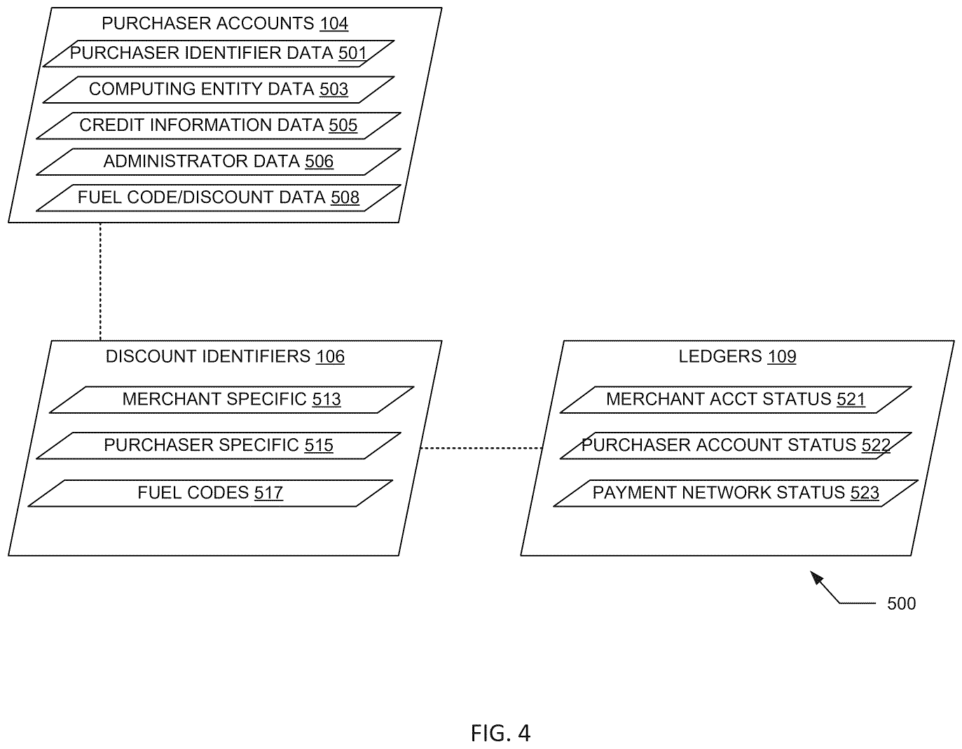

In some embodiments, the data store 102 stores one or more ledgers in ledger data 109, as shown in FIG. 4. The one or more ledgers may comprise a merchant account status ledger 521. As discussed in greater detail below, the merchant account status ledger may comprise data identifying transactions completed, data identifying payments received, and/or data identifying costs owed and/or paid as a part of transactions. The one or more ledgers may additionally comprise purchaser account status ledgers 522. The purchaser account status ledgers 522 may comprise data identifying an amount of credit extended to a purchaser, an amount of credit available to the purchaser, and/or the like. In some embodiments, the purchaser account status ledgers 522 comprise historical data, such as historical transaction data for the purchaser. For example, the purchaser account status ledger 522 may comprise an indication of previous purchases (e.g., historical fuel events). The data may comprise item-level data (e.g., identifying the goods/services purchased) or transaction level data (e.g., identifying the total transaction value). The data may identify the merchant, the location of the transaction, the time/date of the transaction, and/or the like.

In some embodiments, the ledger data comprises a payment network status ledger 523. The payment network status ledger 523 may comprise data identifying transactions completed using the payment network 160. In certain embodiments, the payment network status ledger 523 provides an audit trail of transactions completed in part using a first payment channel of the payment network 160. For example, the payment network status ledger 523 comprises data identifying a merchant and a purchaser involved in a transaction, a payment instrument used for the transaction (or an encrypted indication of the payment instrument used), a time and date of the transaction, the first transaction value of the transaction, an amount of fees collected by the payment network 160, an amount of funds paid by the payment network 160 to the issuer, and/or the like. In some embodiments, the payment network status ledger 523 indicates an amount owed by the payment network 160 to the issuer for one or more transactions.

In some embodiments, the merchant system 103 includes a combination of hardware and software configured to initiate an exchange of value for fuel (e.g., diesel oil, biodiesel, unleaded gasoline, leaded gasoline, off-road rated diesel, off-road rated gasoline, fuel oil, kerosene, propane, jet fuel, boat fuel, ethanol, electricity, liquid hydrogen, and/or the like). For example, the merchant system 103 may include a point-of-sale (POS) terminal having input device(s) that are collectively configured to initiate transactions, specifically to initiate fuel exchanges and exchanges of value for the fuel exchanges. Additionally, in some embodiments, the merchant system is configured to initiate transaction, such as an exchange of value for additional fuel-or vehicle-related goods and services, such as fuel additives, motor oil, windshield washer fluid, anti-freeze solution, vehicle components, vehicle maintenance, weighing services, and/or the like.

In some embodiments, the merchant system 103 includes a point-of-sale (POS) system that comprises one or more input devices 110 configured to receive user inputs. The input devices 110 include a keypad (hard or soft), a touch display, voice/speech or motion interfaces, or other input device. In embodiments including a keypad, the keypad can include (or cause display of) the conventional numeric (0-9) and related keys (#, *), and other keys used for operating the merchant system 103 and may include a full set of alphabetic keys or set of keys that may be activated to provide a full set of alphanumeric keys. In some embodiments, the input device 110 includes a fuel exchange software interface rendered on a display of the merchant system 103 or on a computing device in configured to communicate with the merchant system 103 via wired or wireless communication, such as via a network 150. For example, the merchant system 103 includes a GUI 800 as shown in FIG. 8 and described herein.

In some embodiments, the merchant system 103 includes or is configured to communicate with and control one or more fueling systems 112. In some embodiments, the fueling system 112 is a system configured to control access to fuel. For example, the fueling system 112 may be a device, such as a fuel pump, that dispenses fuel to a purchaser, a vehicle, and/or a fuel container. In one example, the fueling system 112 may be device that enables and disables a fuel pump handle that controls access to fuel from a fuel pump reservoir. In another example, the fueling system 112 may be a device, such as an adjustable valve, that enables and disables access to a fuel pump reservoir. In another example, the fueling system 112 may include a locking mechanism that enables and disables access to a fuel storage receptacle and/or retrieval of a fuel container. In another example, the fueling system 112 may be a system that reserves or saves an allotment of fuel for collection by a purchaser, such as for a wholesale fuel exchange between a fuel supplier and fuel vendor.

In some embodiments, the fueling system 112 is configurable between an inactive state and an active state. In some embodiments, when configured to the inactive state, the fueling system 112 is incapable of or prevents a purchaser from dispensing fuel, or otherwise providing access to fuel. In one example, the fueling system 112 is a fuel pump and, in the inactive state, the fuel pump is rendered inoperable for dispensing fuel. In another example, the fueling system 112 is a storage receptacle comprising a locking mechanism and, in the inactive state, the locking mechanism is enabled to prevent opening of the storage receptacle and/or extraction of a fuel container from the storage receptacle. In some embodiments, when configured to the active state, the fueling system 112 allows a purchaser to dispense fuel or retrieve fuel from a storage receptacle. For example, the fueling system 112 is a fuel pump and, in the active state, the fuel pump is operable for dispensing fuel. In another example, the fueling system 112 is a storage receptacle comprising a locking mechanism and, in the active state, the locking mechanism is disabled to permit opening of the storage receptacle and/or retrieval of a fuel container from the storage receptacle.

In some embodiments, the merchant system 103 (or a computing device of the merchant system 103) stores and runs executable computer instructions (e.g., point-of sale (POS) software, fueling system control program, and/or the like). In some embodiments, by executing the computer instructions, the merchant system controls activation and deactivation of a fueling system 112 by transitioning the fueling system 112 between an inactive state and an active state. In one example, the computer instructions include POS software that, when run by the merchant system 103, allow the merchant system 103 to activate and deactivate one or more fuel pumps at a fueling location based on a fuel exchange. In some embodiments, the computer instructions, when executed, enable the merchant system 103 to transition the fueling system 112 between inactive and active states based on one or more aspects of a fuel exchange. In some embodiments, the computer instructions, when executed, enable the merchant system 103 to generate and render graphical user interfaces on a display provided to an operator of a fueling station. In various embodiments, the graphical user interfaces facilitate receipt of particular types of input data for authorizing a fuel exchange.

The merchant system 103 is configured to generate transaction data, such as an indication of the products or services purchased (e.g., a stock keeping unit (SKU) or other indicator), a quantity of the product or services purchased, and/or the like. As another example, the transaction data may comprise an indication of a type of fuel being provided to the purchaser, such as diesel oil, biodiesel, unleaded gasoline, leaded gasoline, off-road rated diesel, off-road rated gasoline, fuel oil, kerosene, propane, jet fuel, boat fuel, ethanol, electricity, liquid hydrogen, fuel octane level, and/or the like. In still another example, the transaction data may include identifying information for a fueling system 112 (e.g., a fuel pump number and/or the like) by which fuel is provided to the purchaser. In another example, the transaction data may include a current volume of fuel provided during an in-progress fuel exchange, maximum fuel volume for the fuel exchange, total fuel volume provided for a completed fuel exchange, and/or the like. In some embodiments, the merchant system 103 updates and stores the transaction data in substantially real-time such that the transaction data may be accessed and/or transmitted by the networks 150, 160. In some embodiments, the merchant system 103 is associated with a merchant account stored at the remote computing entity 101. The merchant account comprises an identifier for identifying the merchant system 103 and comprises merchant-specific data. The merchant-specific data may comprise data such as a geolocation of the merchant, a name of the merchant, photos of the merchant, identifiers of fuel dispensers (e.g., fuel pumps) at the merchant, identifiers of services provided by the merchant (e.g., showers, fuel-types, restaurant, and/or the like). Certain of this merchant data may be provided to purchaser computing entities 111 that are connected with the remote computing entity 101.

The merchant-specific data additionally comprises merchant-specific payment data for passing payments to and from the merchant (e.g., using ACH or another payment method constituting the second payment channel). This information is not provided to purchaser computing entities 111. The merchant-specific payment data may comprise payment account information (e.g., at a financial institution), credit account information, electronic wallet information, and/or the like. This payment account information may be usable by the remote computing entity 101 to initiate payments to and/or from the merchant's account using a second payment channel that uses network 150 and is separate from the payment network 160. In some embodiments, the merchant account comprises historical transaction data for the merchant, including a ledger of transactions occurring at the merchant (with various purchasers) that utilized the remote computing entity 101 for settlement of at least a part of the transaction. The ledger may distinguish amounts paid by a purchaser to the merchant, amounts paid by the merchant to a payment network (e.g., fees for usage of the payment network), amounts paid by the merchant to the issuer/remote computing entity 101 (e.g., fees/reimbursement for usage of the issuer/remote computing entity 101), and/or the like. These amounts may be provided on a gross-basis (e.g., gross total amount of sales for a period of time) or a transaction-specific basis (e.g., demonstrating the amount paid by a purchaser for a particular transaction and the amounts paid to the payment network and remote computing entity 101 for the same transaction). The payments for a particular transaction may occur at different times, which may be several hours or days apart (e.g., the merchant may pay the payment network hours after a transaction with a purchaser closes, and the merchant may pay the issuer hours or days later). Therefore, the remote computing entity 101 uses transaction identifiers to correlate all of the payments relating to a single transaction for storage within the merchant account.

As discussed above, certain discount identifiers 106 may be merchant-specific discounts, and these discount identifiers 106 may be generated based on data updated and/or otherwise stored within a merchant account. For example, a merchant may update data stored within the merchant account to define the qualifications for discounts and/or to define the type and/or amount of discount. As an example, a merchant may store data indicating that fuel is to be discounted 2% off of a published price for purchasers having accounts with the remote computing entity 101. In certain embodiments, discounts may be both purchaser and merchant specific (e.g., tied to a fuel code that is only usable by a single purchaser at a single merchant). The merchant account may store data reflecting active discounts that are merchant and purchaser specific. These may be unredeemed and unexpired discounts, along with associated data identifying purchasers for which the discounts apply, and data identifying the amount of each discount. In some embodiments, the merchant account additionally stores data of redeemed and/or expired discounts that are purchaser and merchant specific.

Moreover, the merchant account defines APIs or other connections enabling the remote computing entity 101 to receive or retrieve data identifying published prices of goods/services for which various discounts may apply. For example, the merchant account may comprise an API enabling the remote computing entity 101 to obtain fuel pricing published by the merchant. The published prices of goods/services may be stored within the merchant account and may be updated in real-time or periodically.

### Exemplary Purchaser Computing Entity

A purchaser may interact with a purchaser computing entity 111 via a user interface thereon, and/or the purchaser may interact with a purchaser computing entity 111 to obtain information/data regarding a purchaser account 104, one or more discount identifiers 106, one or more identifiers 108, fuel exchange data, and/or an instrument of exchange associated with a purchaser. As will be recognized, an instrument of exchange associated with a purchaser, purchaser account 104, and/or purchaser computing entity 111 may be any of a number of different instrument types, including a credit instrument, debit instrument, cryptographic asset wallet, bank-administrated financial account, non-bank-administered financial account, and/or the like.

A payment instrument 625 may include a credit card associated with a credit account administered by a financial institution or other credit-providing entity using a payment network 160 that can provide payments on behalf of a purchaser, and to which the purchaser is obligated to reimburse for such payments. A debit instrument may include a debit card associated with a purchaser's checking account, savings account, or other deposit account and by which payments may be made on behalf of the purchaser via transfer of assets out of the corresponding deposit account using the debit instrument to verify the transfer. A bank-administered financial account may include a bank-administered checking account, savings account, money market account (MMA), certificate of deposit account (CD), and/or the like, that holds financial assets of a purchaser and by which payments may be made on behalf of the purchaser via electronic funds transfer (EFT), such as via an automated clearing house (ACH). The financial system 140 may be a computing system of a bank (or other financial institution) that manages accounts for the issuer and merchant (and in some instances, the purchaser). As shown the financial system 140 includes memory 144 and processors 146 that collectively enable the financial system to manage and maintain financial accounts for various entities. A non-bank-administered financial account may be a financial account associated with a non-banking entity that holds financial assets on behalf of a purchaser and by which payments may be made on behalf of the purchaser via transfer of the financial assets via a payment platform. Non-limiting examples of a non-bank-administered financial account include digital wallets (e.g., PayPal, Venmo, Zelle, and/or the like), accounts on stock or commodity trading platforms, accounts on person-to-person or business-to-business lending platforms, and/or the like. A cryptographic asset wallet may include a device, physical medium, program, or service that stores public and/or private keys for authorizing transfers of cryptographic assets (e.g., Bitcoin, Ethereum, Tether, and/or the like) via a distributed ledger service, such as a blockchain protocol or smart contract (e.g., Bitcoin protocol, Ethereum network, TRON network, etc.).

In some embodiments, the purchaser computing entity 111 and financial system 140 includes one or more components that are functionally similar to those of the remote server 200. As noted previously, the terms device, system, computing entity, entity, server, and/or similar words used herein interchangeably may refer to at least, for example, one or more computers, computing entities, mobile phones, tablets, phablets, watches, glasses, ear pieces, wristbands, wearable items/devices, fobs, other internet-of-things (IOT) devices, and/or the like, and/or any combination of devices or entities adapted to perform the functions, operations, and/or processes described herein. In some embodiments, the purchaser computing entity 111 includes one or more displays 118, one or more input devices 120, an application 122, and memory 124. In some embodiments, the purchaser computing entity 111 includes an antenna 126, a transmitter 128 (e.g., radio), a receiver 130 (e.g., radio), and a processing element 132 (e.g., CPLDs, microprocessors, multi-core processors, cloud processors, coprocessing entities, ASIPs, microcontrollers, and/or controllers) that provides signals to and receives signals from the transmitter 128 and receiver 130, respectively.

In one embodiment, the signals provided to and received from the transmitter 128 and the receiver 130, respectively, may include signaling information/data in accordance with air interface standards of applicable wireless systems. In this regard, the purchaser computing entity 111 may be capable of operating with one or more air interface standards, communication protocols, modulation types, and access types. More particularly, the purchaser computing entity 111 may operate in accordance with any of a number of wireless communication standards and protocols, such as those described above with regard to the remote server 200 or merchant system 103. In a particular embodiment, the purchaser computing entity 111 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the purchaser computing entity 111 may operate in accordance with multiple wired communication standards and protocols, such as those described above with regard to the remote server 200 via a network 150.

Via these communication standards and protocols, the purchaser computing entity 111 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). In one embodiment, the purchaser computing entity 111 can also download changes, add-ons, and updates, for instance, to its firmware, software (e.g., including executable instructions, applications, program modules), and operating system.

According to one embodiment, the purchaser computing entity 111 may include location determining aspects, devices, modules, functionalities, and/or similar words used herein interchangeably. For example, the purchaser computing entity 111 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). In one embodiment, the satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the purchaser computing entity 111 in connection with a variety of other systems, including cellular towers, Wi-Fi access points, and/or the like. Similarly, the purchaser computing entity 111 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, Bluetooth Smart, Wi-Fi Direct transmitters, NFC transmitters, and/or the like. These indoor positioning aspects can be used in a variety of settings to determine the location of someone or something to within inches or centimeters.

In some embodiments, the purchaser computing entity 111 includes an application 122 that accesses services and functions of the remote computing entity 101. For example, the purchaser computing entity 111 may communicate with the remote computing entity 101 using the application 122. In some embodiments, the remote computing entity 101 provides information about merchants that provide discounts to purchasers via the issuer/remote computing entity 101, using the application 122. In some embodiments, the remote computing entity 101 provides a map graphical user interface within application 122 to guide purchasers to certain merchants. In some embodiments, the application 122 transmits request for generation and receipt of discount identifiers 106 (e.g., fuel codes) to the remote computing entity 101. For example, the application 122 causes the purchaser computing entity 111 to generate a graphical user interface by which a purchaser may provide a user input for requesting generation and receipt of a fuel code 106 for a fueling location associated with a fuel entity. In response to the purchaser computing entity 111 receiving the user input, the application 122 may generate and transmit to the remote computing entity 101 a fuel code request including the fueling location, an identifier for the fuel entity, a timestamp of the user input, a location of the purchaser computing entity 111, and/or the like. In some embodiments, the application 122 receives a fuel code 106 from the remote computing entity 101 and stores the fuel code 106 in memory 124 of the purchaser computing entity 111. In some embodiments, the application 122 causes the purchaser computing entity 111 to generate and render graphical user interfaces for requesting a fuel code 106, displaying a location of the purchaser computing entity 111, displaying a location of one or more fueling locations, displaying a fuel exchange ratio for one or more fueling locations, accessing and displaying information associated with a purchaser account 104, accessing and displaying historical fuel exchange data, and/or the like. An example graphical user interface that may be generated by the application 122 and rendered on the purchaser computing entity 111 is depicted by the graphical user interface 900 shown in FIG. 9 and described herein.

In one example, the application 122 communicates with the remote computing entity 101 to receive geolocation data indicative of a location of one or more fueling locations. The application 122 may cause the purchaser computing entity 111 to generate and render a graphical user interface including a map on which the locations of the one or more fueling locations are rendered.

In some embodiments, the application 122 interfaces with other software or applications installed or running on the purchaser computing entity 111. Such software may include geolocation software, Internet browsing software, image capture software, user authentication software, and software that manages or provides access to information associated with a purchaser's instrument of exchange (e.g., credit cards, debit cards, banking accounts, cryptographic asset wallets, and other payment instruments). In one example, the application 122 interfaces with a navigation application to determine and provide a location of the purchaser computing entity 111 to the remote computing entity 101 and/or generate a graphical user interface including a virtual map that displays the location and one or more fueling locations. In another example, the application 122 interfaces with a payment instrument management application to obtain and provide to the remote computing entity 101 various data associated with the purchaser's instrument of exchange (e.g., credit card number, expiration data, card verification value, and/or the like).

In one embodiment, the purchaser computing entity 111 may also comprise a user interface 117 (that can include a display 118 coupled to a processing element 132), which may include user input interface (coupled to a processing element 132 (e.g., which may be embodied as one or more processors)). For example, the user interface 117 may be an application 122, browser, user interface, interface, and/or similar words used herein interchangeably executing on and/or accessible via the purchaser computing entity 111 to interact with and/or cause display of information/data from the remote server 200, as described herein. The user input interface can comprise any of input devices 120 allowing the purchaser computing entity 111 to receive data, such as a keypad (hard or soft), a touch display, voice/speech or motion interfaces, or other input device. In embodiments including a keypad, the keypad can include (or cause display of) the conventional numeric (0-9) and related keys (#, *), and other keys used for operating the purchaser computing entity 111 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

In certain embodiments, the user interface (e.g., the display 118) may be configured for displaying fuel codes that may be provided or presented to a merchant system 103 to initiate and enable authorization of a fuel exchange. For example, the user interface of the purchaser computing entity 111 may be utilized to display a QR code, a bar code, an image, and/or the like that is machine-readable and indicative of a fuel code. Similarly, the purchaser computing entity 111 may be configured for storing fuel codes thereon, and transmitting inputs indicative of fuel codes via any of a variety of wireless data transmission protocols (e.g., Bluetooth, Wi-Fi, NFC, and/or the like) to the merchant system 103.

In some embodiments, the purchaser computing entity 111 includes memory 124, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The memory 124 may include volatile memory and/or non-volatile memory. The memory 124 can store databases, database instances, database management systems, data, applications, programs, program modules, scripts, source code, object code, byte code, compiled code, interpreted code, machine code, executable instructions, and/or the like to implement the functions of the purchaser computing entity 111. The memory 124 can store fuel codes, data associated with a purchaser account 104, identifiers 108, and/or fuel exchange data. As indicated, this may include an application 122 that is resident on the purchaser computing entity 111 or accessible through a browser or other user interface for communicating with the remote server 200, merchant system 103, and/or various other computing entities.

As will be recognized, the purchaser computing entity 111 may include one or more components or functionality that are the same or similar to those of the remote server 200, as described in greater detail below. As will be recognized, these architectures and descriptions are provided for exemplary purposes only and are not limiting to the various embodiments.

### Exemplary Networks

In one embodiment, any two or more of the illustrative components of the architecture of FIG. 1 may be configured to communicate with one another via respective communicative couplings to one or more networks 150, 160. The networks 150, 160 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 150, 160 may have any suitable communication range associated therewith and may include, for example, global networks (e.g., the Internet), metropolitan area networks (MANs), wide area networks (WANs), local area networks (LANs), or personal area networks. In addition, the networks 150 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Transmissions over networks 150, 160 may be “in the clear” or may leverage one of more of a variety of industry-standard or third-party security technologies implemented in any of the OSI layers used. If encryption is used, it may be symmetric or asymmetric (or implement a combination of the two, as in SSL/TLS, where the initial handshake uses asymmetric encryption in the exchange of symmetric keys, and subsequent transactions use symmetric encryption based on the previously exchanged symmetric keys). As will be recognized, process interaction over a network may be synchronous or asynchronous: synchronous-processes are coupled and include web services (e.g., SOAP), which may in turn leverage http(s); and various other remote procedure call (RPC), middleware protocols, industry-standard exchange formats (e.g., XML or JSON), and integration architectures (e.g., REST) and/or asynchronous-processes are decoupled and mechanisms include message queues and file transfers.

As discussed throughout this disclosure, networks 150, 160 may provide distinct functionalities from one another, and/or may be characterized by different entity access capabilities. For example, data transmissions (and payments) made using network 150 may be encrypted and inaccessible to a manager of a payment network 160. As a specific example, a payment made using network 150 may not be visible to VISAR or other payment networks 160, and therefore the payment made using a second payment channel of network 150 does not use any of the feature or functionality of payment networks 160. By contrast, a payment made using a first payment channel of payment network 160 is visible to the payment network 160 (e.g., VISAR for certain payment networks), so that the payment network ensures the payment remains secure, and so that the payment network can deduct a percentage of the first transaction value (calculated based on the published/publicly advertised price of goods/services) as reimbursement for the services provided from the payment network 160.

In both instances, data and payments transferred using networks 150 and 160 may be encrypted and/or otherwise secure against unauthorized third parties attempting to intercept the payment or information identifying the payment.

### Exemplary Remote Server

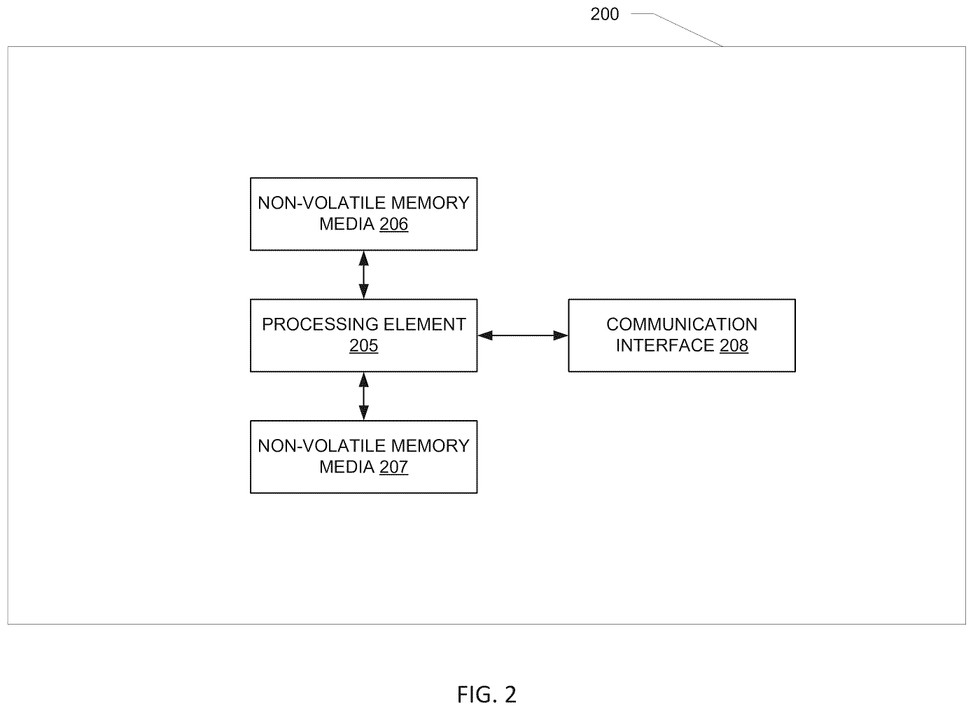

FIG. 2 provides a schematic of a remote server 200 of a remote computing entity according to one embodiment. In one embodiment, the remote server 200 may be in network communication with one or more purchaser computing entities 111, one or more computing systems associated with administrating and/or issuing an instrument of exchange, and/or the like. In certain embodiments, the remote server 200 may be operable in association with other computing devices and/or platforms (e.g., operable via third parties, such as banking institutions' online banking platforms) to accomplish certain functions (e.g., user authentication) to retrieve certain data, and/or the like. In general, the terms computing entity, computer, entity, device, system, server, machine, and/or similar words used herein interchangeably may refer to, for example, one or more computers, computing entities, desktop computers, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, controlling, remotely controlling, dispensing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

In one embodiment, the remote server 200 may include or be in communication with one or more one or more processing elements 205 (also referred to as processors, processing circuitry, processing device, and/or similar terms used herein interchangeably) that communicate with other elements within the remote server 200 via a bus, for example. In certain embodiments, the processing element may access various data to perform functions of the remote server 200, such as purchaser accounts (e.g., user (login) ID, password (or other authentication credential(s), user name, user registration status, and/or the like), fuel codes, identifiers, fuel exchange data, and/or the like. As will be understood, the processing element 205 may be embodied in a number of different ways. For example, the processing element 205 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile memory or otherwise accessible to the processing element 205. As such, whether configured by hardware or computer program products, or by a combination thereof, the processing element 205 may be capable of performing steps or operations according to embodiments of the present techniques for fuel exchange authorization and optimization when configured accordingly.

In one embodiment, the remote server 200 may further include or be in communication with non-volatile memory 206 (also referred to as non-volatile storage, memory, memory storage, memory circuitry and/or similar terms used herein interchangeably), which may include or be embodied as one or more data stores 102. In one embodiment, the non-volatile storage or memory may include one or more non-volatile storage or memory media 206, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media 206 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like.

In one embodiment, the remote server 200 may further include or be in communication with volatile memory 207 (also referred to as volatile storage, memory, memory storage, memory circuitry and/or similar terms used herein interchangeably), which may include or be embodied as one or more data stores 102. In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the remote server 200 with the assistance of the processing element 205 and operating system.

As indicated, in one embodiment, the remote server 200 may also include one or more communications elements/interfaces 208 for communicating with various computing entities, such as by communicating data, content, information, and/or similar terms used herein interchangeably that can be transmitted, received, operated on, processed, displayed, stored, and/or the like. For instance, the remote server 200 may communicate with one or more networks 150, one or more purchaser computing entities 111, one or more merchant systems 103, one or more computing systems associated with administration or issuance of an instrument of an exchange (e.g., banking institutions, credit and/or debit card networks, cryptographic asset environments, such as blockchains, etc.,), and/or the like.

In certain embodiments, the remote server 200 may be configured to authorize fuel exchanges based at least in part on receipt and processing of data as described herein. The remote server 200 may receive a fuel exchange payload as a part of transaction data generated by the merchant system respective to a fuel event, where the fuel exchange payload indicates a fuel exchange amount. The remote server 200 may authorize and initiate an exchange of value for the fuel exchange amount using a purchaser's instrument of exchange. Thus, the remote server may enable authorization and initiation of fuel exchanges without exposing sensitive information for the instrument of exchange to the merchant system (e.g., also eliminating a need for a purchaser to present such information to an operator of the merchant system).

As indicated, in one embodiment, the remote server 200 may also include one or more communications interfaces 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the remote server 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The remote server 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Although not shown, the remote server 200 may include or be in communication with one or more input elements, such as a keyboard input, a mouse input, a touch screen/display input, motion input, movement input, audio input, pointing device input, joystick input, keypad input, and/or the like. In one embodiment, the remote server 200 may also include or be in communication with one or more output elements (not shown), such as audio output, video output, screen/display output, motion output, movement output, and/or the like.

As will be appreciated, one or more of the components of the remote server 200 may be located remotely from other remote server 200 components, such as in a distributed system. Furthermore, one or more of the components may be combined and additional components performing functions described herein may be included in the remote server 200. Thus, the remote server 200 can be adapted to accommodate a variety of needs and circumstances. As will be recognized, these architectures and descriptions are provided for exemplary purposes only and are not limiting to the various embodiments.

### Exemplary Merchant System

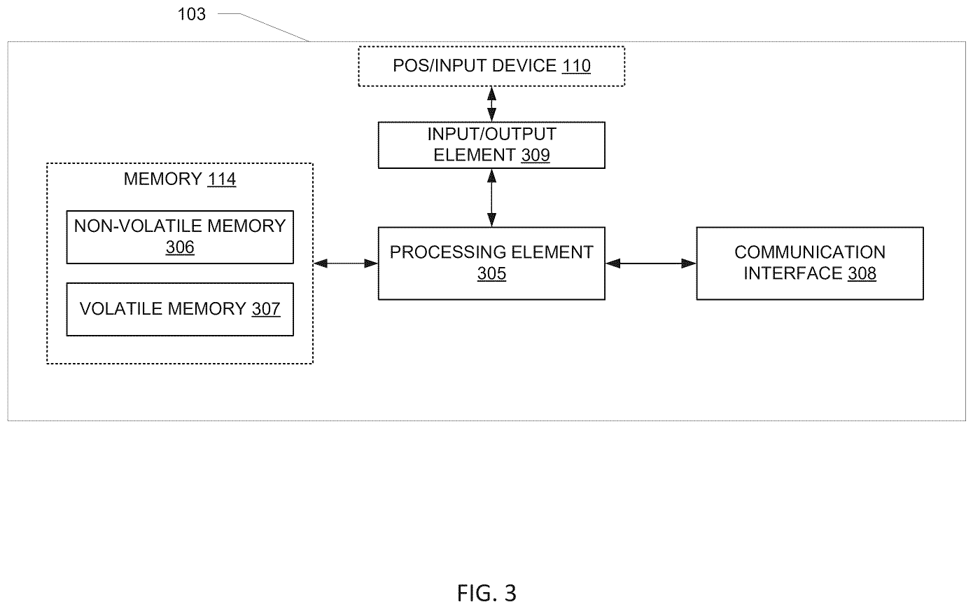

FIG. 3 provides a schematic of a merchant system 103 according to one embodiment. In one embodiment, the merchant system 103 may be in network communication with one or more purchaser computing entities 111, one or more remote computing entities 101, computing systems associated with administrating and/or issuing an instrument of exchange, and/or the like. The merchant system 103 may communicate via network 150 and payment network 160. In certain embodiments, the merchant system 103 may be operable in association with other computing devices and/or platforms (e.g., operable via third parties, such as banking institutions' online banking platforms) to accomplish certain functions (e.g., receiving user input, generating and providing fuel exchange authorization data objects and fuel exchange payloads, etc.) to retrieve or provide certain data, and/or the like.

In various embodiments, the merchant system 103 includes or embodies one or more computers, computing entities, desktop computers, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, controlling, remotely controlling, dispensing, displaying, storing, determining, creating/generating, monitoring, evaluating, comparing, and/or similar terms used herein interchangeably. For example, the merchant system 103 may receive user inputs indicative of fuel codes and other fuel exchange-related data, such as an identifier for a fueling system by which fuel may be provided to a purchaser. As another example, the merchant system 103 may control a fueling system, such as by transitioning a fueling system between inactive and active states, based on data received from a remote computing entity via a fuel exchange processing service and one or more APIs. In another example, the merchant system 103 processes a user input based on a storage instruction and determines that the user input includes a format corresponding to a fuel code payment type. In another example, in response to recognizing a user input as indicative of a fuel code, the merchant system transforms the user input into a data format by which the user input may be transmitted to or collected by a fuel exchange processing service and provided to a remote computing entity using one or more APIs. In one embodiment, these functions, operations, and/or processes can be performed on data, content, information, and/or similar terms used herein interchangeably.

In one embodiment, the merchant system 103 may include or be in communication with one or more processing elements 305 (also referred to as processors, processing circuitry, processing device, and/or similar terms used herein interchangeably) that communicate with other elements within the merchant system 103 via a bus, for example. In certain embodiments, the processing element 305 may access or receive data associated with performing functions described herein, such as user inputs, fuel codes, validations or rejections of fuel codes, fuel exchange-related data (e.g., fuel volumes, fuel volume limits, fuel types), and/or the like. As will be understood, the processing element 305 may be embodied in a number of different ways. For example, the processing element 305 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in memory 114 (e.g., in volatile or non-volatile memory) or otherwise accessible to the processing element 305. As such, whether configured by hardware or computer program products, or by a combination thereof, the processing element 305 may be capable of performing steps or operations according to embodiments of the present techniques for fuel exchange authorization and optimization when configured accordingly. In various, functions of the processing element 305, and/or other elements of the merchant system 103, are modified according to storage instructions. Such storage instructions, when executed by the processing element 305, may enable the merchant system 103 to recognize user input for fuel codes as a valid identifier for an instrument of exchange. When executed by the processing element 305, the storage instructions may also cause the merchant system 103 to transform such user input, and potentially other fuel exchange-related data, into a format by which the user input may be provided to or collected by an external computing system, such as via one or more APIs.

In one embodiment, the merchant system 103 may further include or be in communication with non-volatile memory 306 (also referred to as non-volatile storage, memory, memory storage, memory circuitry and/or similar terms used herein interchangeably), which may include or be embodied as memory 114. In one embodiment, the non-volatile storage or memory may include one or more non-volatile storage or memory media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like. In some embodiments, the non-volatile memory 306 stores storage instructions 116 that cause the processing element 305 to modify a format of user input data stored at the merchant system 103 to enable performance of functions described herein for remotely initiating and executing fuel exchanges based on user inputs indicative of fuel codes.

In one embodiment, the merchant system 103 may further include or be in communication with volatile memory 307 (also referred to as volatile storage, memory, memory storage, memory circuitry and/or similar terms used herein interchangeably), which may include or be embodied as one or more data stores 102. In one embodiment, the volatile storage or memory may also include one or more volatile storage or memory media 307, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 305. Thus, the databases, database instances, database management systems, data, applications, programs, program modules, scripts, source code, object code, byte code, compiled code, interpreted code, machine code, executable instructions, and/or the like may be used to control certain aspects of the operation of the merchant system 103 with the assistance of the processing element 305 and operating system. In some embodiments, the volatile memory 307 temporarily stores user inputs according to a storage instruction 116. For example, in response to the processing element 305 recognizing a user input as indicating a fuel code (e.g., via execution of the storage instruction 116), the volatile memory 307 temporarily stores the user input according to the storage instruction 116.

As indicated, in one embodiment, the merchant system 103 may also include one or more communications elements/interfaces 308 for communicating with various computing entities, such as by communicating data, content, information, and/or similar terms used herein interchangeably that can be transmitted, received, operated on, processed, displayed, stored, and/or the like. For instance, the merchant system 103 may communicate with one or more networks 150, payment networks 160, one or more purchaser computing entities 111, a remote computing entity 101, one or more fueling systems 112, one or more computing systems associated with administration or issuance of an instrument of an exchange (e.g., banking institutions, credit and/or debit card networks, cryptographic asset environments, such as blockchains, etc.), and/or the like.

In some embodiments, the merchant system 103 includes one or more input/output elements 309 that receive an indication of a user input and, in some embodiments, provide an output or input to one or more computing devices. In some embodiments, the input/output element 309 embodies or communicates with the input device 110 (which may be a part of, or may be embodied as a POS). For example, the input/output element 309 provides output to and receives input from one or more computing devices (e.g., purchaser computing entities 111, input devices 110, and/or the like). In one example, the input/output element 309 receives a user input indicative of a fuel code, a fuel type, a fueling system, and/or the like. In some embodiments, the input/output element 309 provides user inputs to the processing element 305. The input/output element 309 may comprise one or more fuel exchange software interface(s) and in some embodiments includes a display that comprises the interface(s) rendered as a web user interface, an application user interface, a purchaser device, a backend system, or the like. In some embodiments, the input/output element 309 also includes a keyboard, a mouse, a joystick, a touch screen, touch areas, soft keys, a microphone, a speaker, and/or other input/output mechanisms.

In certain embodiments, using the processing element 305, memory 114, communication interface 308, and input/output element 309, the merchant system 103 may be configured to obtain authorization for fuel exchanges based at least in part on receipt and processing of data as described herein. For example, the merchant system 103 may receive a user input and/or other input indicative of a requested fueling transaction. Transaction data may be passed to the remote computing entity 101 using the payment network 160. The merchant system 103 may receive an authorization from the remote computing entity 101 via a relay of the authorization using the payment network 160. The authorization of the transaction data may cause the merchant system 103 to transition a fueling system from an inactive state to an active state (e.g., potentially based additional fuel exchange data received, such as a fuel volume limit, preauthorization limit, and/or the like). merchant system 103 may determine a fuel volume and generate a fuel exchange amount based on the fuel volume. The merchant system 103 may generate a transaction data payload indicative of the fuel exchange amount and provide the transaction payload to the remote computing entity 101 using the payment network 160 (e.g., using one or more APIs).

As indicated, in one embodiment, the merchant system 103 may also include one or more communications interfaces 308 for communicating with various computing entities, such as by communicating data, content, information, and/or similar terms used herein interchangeably that can be transmitted, received, operated on, processed, displayed, stored, and/or the like over network 150 and/or payment network 160. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the merchant system 103 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The merchant system 103 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS),

Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the components of the merchant system 103 may be located remotely from other merchant system 103 components, such as in a distributed system. Furthermore, one or more of the components may be combined and additional components performing functions described herein may be included in the merchant system 103. Thus, the merchant system 103 can be adapted to accommodate a variety of needs and circumstances. As will be recognized, these architectures and descriptions are provided for exemplary purposes only and are not limiting to the various embodiments.

### Technical Challenges

Existing payment networks and single payment channel transaction settlement processes provide minimal options for merchants, issuers, and/or third party card sponsors to customize the transaction settlement. For example, the use of a single payment channel passing through a payment network does not enable implementation of custom fee structures payable by merchants, discount terms that can be offered to purchasers (e.g., fuel purchasers), and cost recuperation by the card issuers and/or third party card sponsors. Existing payment networks have rigid structures whereby discounts offered by merchants to purchasers must be provided either at a POS or by providing a refund to a purchaser in a later transaction. Discounts offered at a POS are not easily tracked, because transaction data does not provide detail about the level of discount offered, or why the discount was provided. Refunds provided to a customer after a transaction has closed provide similar challenges to the purchaser, who is forced to manually match up the refund to the original transaction. While the purchaser may be able to use the merchant name (or other merchant identifier in transaction data) as a clue to match the refund with the original transaction, this is not always sufficient, particularly where a single purchaser makes multiple purchases from the same merchant and each purchase is subject to a different refund amount. Adding to this difficulty is that refunds are typically processed on separate dates from the original transaction, so transaction dates/times cannot be used to easily match-up refunds with original transactions.

### Technical Solutions

To address these and other challenges involved in physical card transaction processing, multiple payment channels can be established with the merchant. A first payment channel is provided through a payment network (e.g., a credit card network, such as the VISAR payment network) that connects the merchant with an issuer and/or a third party sponsor of the card. A second payment channel is provided outside of the payment network between the merchant and the issuer and/or the third party sponsor of the card. The second payment channel need not flow through the payment network, thereby avoiding fees associated with the use of any payment network. However, the second payment network provides secure transfer of funds between multiple entities, such as between the issuer (and/or the third party card sponsor) and the merchant.

Transaction data (and funding) passed along the first payment channel from the merchant to the issuer reflects a first transaction value based on an undiscounted unit price as established at the POS (and an undiscounted total price for the entire transaction). This undiscounted unit price need not match the discounted price offered to the purchaser based on the purchaser's relationship with the issuer (e.g., if the purchaser holds an account with the issuer). The transaction data is passed through the payment network to the issuer, and the payment network is used to pass a reimbursement amount to the merchant based on the undiscounted total price for the entire transaction, less any fees for use of the issuer and/or payment network. As discussed in greater detail herein, this first payment channel may also be used for pre-transaction authorization and verification processes (e.g., to ensure that an account associated with a purchaser has sufficient credit available for the transaction). Once received at the issuer, the transaction data can be matched with discount values so that the purchaser is billed for a second transaction value at the discounted transaction price. The purchaser therefore pays the discounted price, and need not seek refunds (whether manually or automatically) for the value of the agreed discount.

The second payment channel is used for passing payment from the merchant to the issuer as a cost associated with providing the discount to the purchaser (to at least partially reimburse the issuer for the difference between the first transaction value and the second transaction value). Transaction data passed with this second payment channel is not limited to the transaction data available for provision via the first payment channel. This transaction data may identify the original transaction (e.g., using a unique transaction identifier or other identifying data), the total cost of providing the discount, and/or the discounted unit price provided as a part of the transaction. Transaction data passed via the second payment channel may be sent in real-time, or it may be sent later after the original transaction has been settled.

### Example Operation

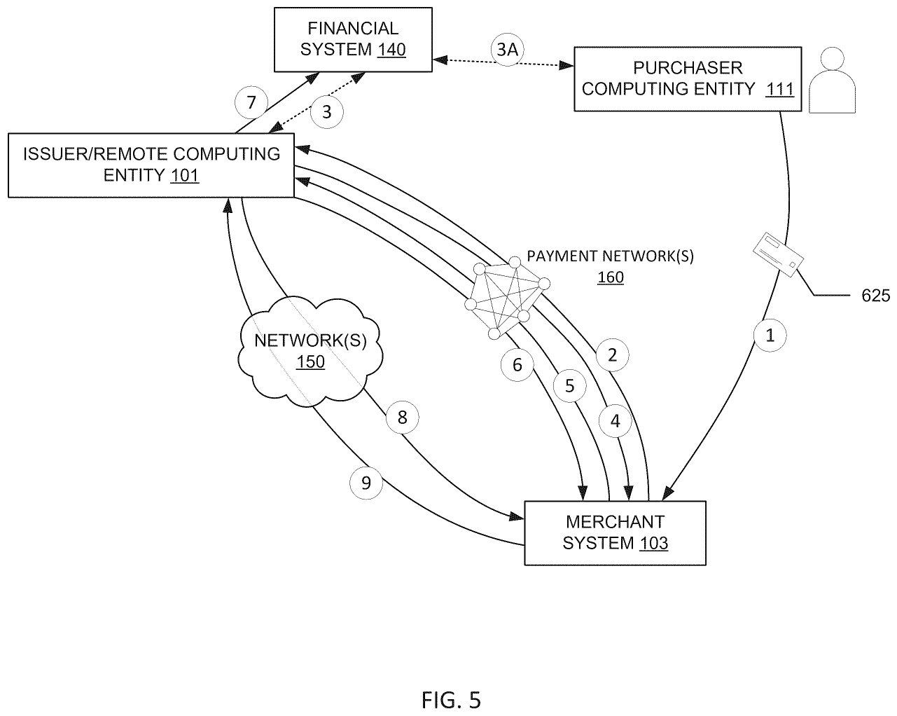

FIG. 5 shows an example process flow for completing a multiple payment channel transaction. As discussed herein, the multiple payment channel transaction enables a purchaser to obtain the benefit of discounts that may not be available to all customers of a particular merchant, but which are provided to the purchaser at least in part because of the purchaser's account held with the issuer/remote computing entity 101. POS systems of a merchant system 103 need not be specifically configured to recognize that a discount is applicable to a particular purchaser. However, certain features of the merchant system 103 (separate from the POS systems) may enable additional payment channels with the issuer/remote computing entity 101 so that funds are appropriately distributed among the various entities as discussed herein.

The example in FIG. 5 is a transaction for a purchaser (with a corresponding purchaser computing entity 111) to purchase goods and/or services from a merchant (with corresponding merchant system 103). The number of illustrations/boxes associated with each entity should not be taken as limiting. For example, a purchaser may have one or more purchaser computing entities 111, and may be associated with one or more purchaser accounts, one or more financial accounts (managed by a bank or other financial entity associated with the financial system 140), and/or the like. Moreover, the example of FIG. 5 is suitable for purchasing fuel (e.g., diesel fuel, gasoline, electricity, and/or other example fuels as discussed herein). In some instances, fuel purchases may be performed by first pre-authorizing a standard transaction value (e.g., $100 may be set as the standard transaction value for all fuel pre-authorizations), which may not be equivalent to the final transaction amount. This pre-authorization step is performed to ensure that a purchaser's payment instrument has sufficient credit (or funding) to complete a purchase having a value of at least the pre-authorization amount. Thereafter, fuel is dispensed, and the final transaction amount is determined. Some systems may limit the final transaction amount to be equal to or less than the pre-authorization amount. Other systems may not impose a limit on the final transaction amount determined based on the pre-authorization amount.

With reference now to FIG. 5, the process is initiated when a purchaser (denoted with purchaser computing entity 111) requests to execute a transaction with a merchant (denoted with merchant system 103), as indicated by line 1 of FIG. 5. For example, the purchaser presents a payment instrument 625 (e.g., a payment card such as a credit card or charge card) to the merchant. Presentation of the payment instrument 625 may include physical presentation of the payment instrument 625 (handing a physical card to a merchant), electronic presentation of the payment instrument 625 (from a digital wallet, for example), or otherwise. The payment instrument 625 is associated with an account at the issuer/remote computing entity 101, and data stored at the issuer/remote computing entity 101 specifies that the transaction should be performed using multiple payment channels. The merchant system 103 (specifically, a POS operating at/by the merchant system 103) need not recognize that a transaction performed with the payment instrument 625 will be a multi-channel transaction. However, the POS of the merchant system 103 is configured to extract certain data from the payment instrument 625, including an account number (or a one-time use token representing the account number), a payment network 160 for processing transactions using the payment instrument 625, and/or the like.

As reflected at line 2 of FIG. 5, the merchant system 103 requests pre-authorization of the transaction, by transmitting pre-authorization transaction data using the payment network 160 (as identified by the POS based on the data extracted from the payment instrument 625) to the issuer/remote computing entity 101. As discussed above, the pre-authorization amount requested by the merchant system 103 may, but need not be, equivalent to the first transaction value.

The issuer/remote computing entity 101 may communicate with the financial system 140 as shown in line 3 of FIG. 5, specifically to check on the funding/credit status of an account associated with the purchaser (as reflected by the dashed connecting line 3A, although it should be understood that this line merely reflects that the account of the purchaser is checked, but the check occurs at the financial system 140 and/or at the issuer/remote computing entity 101). Once the issuer/remote computing entity 101 determines that pre-authorization should be provided (e.g., based on the credit/funding check), the issuer/remote computing entity 101 communicates with the merchant system 103 using the payment network 160 to provide preauthorization for the transaction. The merchant system 103 then proceeds to execute the transaction, by either completing a transaction for goods/services, by activating a fuel pump (for fuel purchases), and/or the like. For some transaction types (e.g., fuel transactions), the merchant system 103 determines first transaction information, including quantity of goods/services (e.g., fuel) purchased, first transaction value (based on published/publicly advertised pricing of goods/services sold), transaction date/time, and/or the like. The merchant system 103 may add additional information to the transaction data in some embodiments, such as a merchant identifier, a fuel system identifier (if applicable) and/or the like.

The merchant system 103 then sends the transaction data (the finalized transaction data) to the issuer/remote computing entity 101 using the payment network 160. The payment network 160 passes payment to the merchant along a first payment channel for the first transaction value, minus a fee payable to the issuer/payment network 160, as shown at line 6.

The issuer/remote computing entity 101 determines a discount applicable to the transaction after receipt of the transaction data from line 5. This discount is applied before the amount is charged to the purchaser's account (which may be held at financial system 140 as reflected at line 7, or may be held at the issuer remote computing entity 101, in which case the connection line 7 is inapplicable in certain embodiments). The issuer/remote computing entity 101 uses one or more look-up tables to identify the discount based on the transaction data. For example, a discount may be purchaser specific, in which case the issuer/remote computing entity 101 uses the purchaser identifier data within the transaction data to reference look-up tables to identify a discount applicable to the purchaser. In some embodiments, the discount may be merchant specific, and so the issuer/remote computing entity 101 uses the merchant identifier within the transaction data to reference look-up tables to identify a merchant-specific discount. In some embodiments, a purchaser may be entitled to different discounts with different merchants, and so the purchaser identifier and the merchant identifier may be used from the transaction data to look up discounts within look-up tables. In some embodiments, the discount may be transaction specific (e.g., based on a fuel code), and the issuer/remote computing entity 101 may use one or more items of data from the transaction data to identify an applicable fuel code and associated discount (e.g., by identifying the purchaser that requested the fuel code, the merchant where the fuel code is valid, the expiration date/time/criteria for the fuel code (is it a 1-time use, must it be used within 24-hours, and/or the like), and/or the like to identify a corresponding discount associated with the fuel code. Where the fuel code is limited to a single use (or a set number of uses), the issuer/remote computing entity 101 updates usage data associated with the fuel code within a memory. Once the discount is determined for the transaction, a second transaction value (equal to the first transaction value, less the discount value) is calculated and applied against the purchaser's account. The second transaction value is less than the first transaction value as determined by the POS system of the merchant system 103, and is less than the amount paid to the merchant using the first payment channel.

The issuer/remote computing entity 101 then calculates a cost amount for the transaction. The cost amount is equal to the amount owed by the merchant to the issuer/remote computing entity 101 to at least partially reimburse the issuer/remote computing entity 101 for the discount provided to the purchaser. In some embodiments, the cost amount may be equal to the discount amount provided to the purchaser, which is equal to the difference between the first transaction value and the second transaction value. In some embodiments, the cost amount may be equal to the discount amount, minus a credit to offset some of the payment network fees. The exact calculation may be application specific.

The merchant pays for the cost amount via second payment channel that uses network 150. In an example embodiment, the issuer/remote computing entity 101 transmits cost data to the merchant system 103 for the cost amount as shown at line 8 of FIG. 5, using the second payment channel. The cost amount is defined within cost data generated by the issuer/remote computing entity 101 and passed to the merchant system 103. The cost data may additionally comprise transaction data so that the cost amount can be easily associated with the original transaction occurring between the merchant and the purchaser. For example, the cost data comprises a transaction identifier (in some cases comprising multiple transaction identifiers, including a first transaction identifier that matches the transaction between the purchaser and the merchant, and a second transaction identifier corresponding to the payment of the cost amount between the merchant and the issuer), a cost identifier (for audit purposes, for example), a transaction date/time, a purchaser identifier associated with the transaction, and/or the like. In some embodiments, the cost data identifies the discount amount (e.g., which may be identified as a total discount, a per-unit discount, and/or the like). The cost data, including the payment request, when passed to the merchant system 103 using network 150 may cause the merchant system 103 to transmit the cost amount to the issuer/remote computing entity 101 using the second payment channel that uses network 150. The payment network 160 need not identify, recognize, audit, or otherwise use any data relating to the payment passed through the second payment channel of network 150.

In other example embodiment, a payment from the merchant to the issuer/remote computing entity 101 for the cost amount may be performed by deducting the cost amount from an amount owed by the issuer/remote computing entity 101 to the merchant, for other unrelated fees/services provided by the issuer/remote computing entity 101 to the merchant. For example, the issuer may process certain transactions (e.g., by receiving transaction data, identifying a discount, recouping funds from the purchaser based on the discounted amount, and causing the merchant to be reimbursed for the transaction) on behalf of the merchant system, and the cost amount may be deducted from a settlement amount for the other transactions. In such instances, the payment using the second payment channel passes from the issuer/remote computing entity 101 to the merchant system 103.

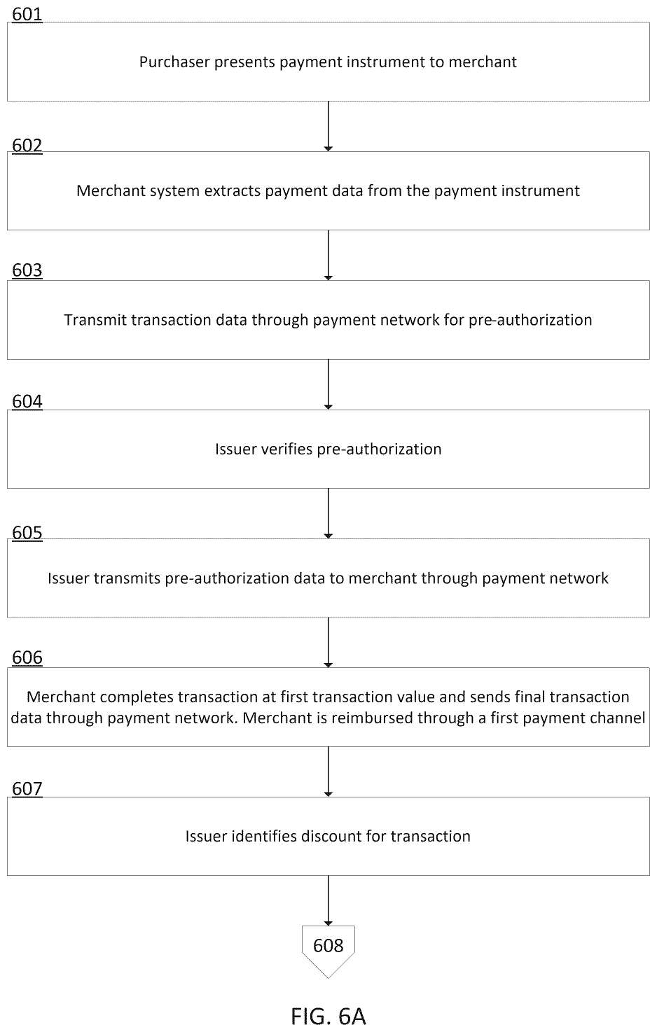

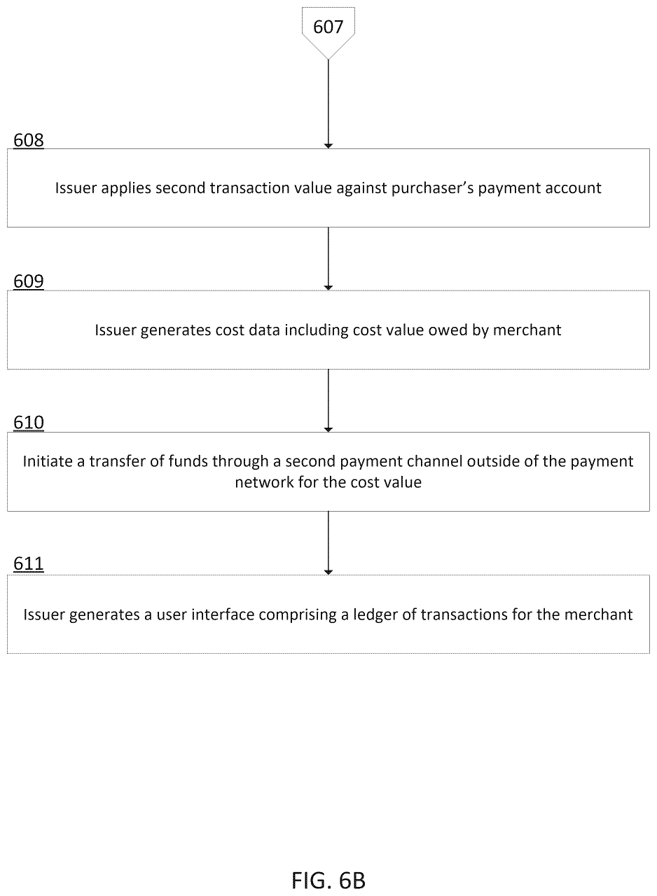

FIG. 6 is a flowchart illustrating the various steps for settling a transaction, as discussed with respect to FIG. 5. In some embodiments, a purchaser (the user of a payment instrument 625) may request a fuel code with corresponding discount prior to the transaction process described in FIGS. 5-6. In such embodiments, the fuel code, its corresponding discount, and the merchant(s) and purchaser(s) that can use the fuel code (and its corresponding discount) may be stored in memory of the remote computing entity 101 for retrieval during the transaction process as discussed herein.

The transaction process begins when the purchaser requests a transaction with a merchant. As an example, a purchaser (driver/user of a vehicle) seeks to purchase fuel from a merchant. The purchaser presents a payment instrument 625 (e.g., a physical payment card, or an electronic and/or encrypted representation of a payment card) to the merchant to initiate a transaction, as shown at 601. In the fuel-purchase setting, this typically occurs prior to the purchaser dispensing fuel into a container/vehicle, and so the total amount of fuel to be purchased (and the corresponding first transaction value) is not known at this stage. The merchant system 103 receives the payment instrument 625 and extracts payment data therefrom at 602. The payment data may comprise a payment account number/identifier and/or any additional data needed to authorize a transaction using the payment instrument 625. As a part of extracting the payment data, the merchant system 103 identifies a payment network 160 for processing the payment and an issuer for the payment instrument 625.

The merchant system 103 generates transaction data including the payment data (or an encrypted representation thereof), a merchant identifier, a transaction identifier, a transaction date/time stamp, goods/services to be purchased, a quantity and/or value of the goods/services to be purchased (or a pre-authorization quantity/value, if the quantity is not known), and/or the like. This transaction data is transmitted through the payment network 160 to the issuer/remote computing entity 101, as shown at 603. In certain embodiments, the merchant system 103 passes the transaction data to the payment network 160, and a third party passes detailed transaction data from the payment network 160 to the issuer/remote computing entity 101.

The issuer/remote computing entity 101 verifies that the payment account associated with the payment instrument 625 is authorized to complete the transaction (or at least to complete a pre-authorization amount for the transaction, if the actual, first transaction value is not known), as shown at 604. Verification of transaction authorization may entail determining whether the payment account has a sufficient credit availability to complete the transaction. In certain embodiments, this may be completed using communications with a financial institution. In other embodiments, this may be completed by the remote computing entity 101, without communication to external systems. In certain embodiments, other criteria may be utilized to ensure authorization, including reviewing transaction rules established for the purchaser's account (e.g., by an administrator) that may set a spending limit (e.g., a total spending limit or daily spending limit), a limit on the types of good/services purchased (e.g., only allowing diesel fuel purchases), a limit on the merchants that can be purchased from, and/or the like.

Once the issuer/remote computing entity 101 verifies that the transaction is authorized, the issuer/remote computing entity 101 passes authorization data through the payment network 160 to the merchant system 103 as shown at 605. Where the first transaction value is known, the transaction may be completed. Where the first transaction value is not known, the merchant system 103 may enable systems configured for dispensing goods (e.g., fuel) until a first transaction value is determined (based on published/publicly advertised pricing). The merchant system 103 then sends final transaction data through the payment network 160 to the issuer/remote computing entity 101 as shown at 606. The payment network 160 then initiates payment of the first transaction value from the issuer, less any fees owed to the issuer/payment network, to the merchant system using a first payment channel of the payment network 160 as shown at 607. The fees are split between the payment network 160 and the issuer (e.g., the issuer may provide a portion of the fees to an account associated with the payment network 160, or vice versa). The payment may be deposited into a financial account associated with the merchant and may originate from an account of the issuer.

Once the issuer/remote computing entity 101 receives the final transaction data, the issuer/remote computing entity 101 queries databases storing discount identifiers to determine the total amount of discount that should be applied to the transaction. As mentioned, the discounts may be purchaser specific, merchant specific, purchaser and merchant specific, and/or the like. In certain embodiments, discounts may be product/service specific, such that only a portion of a transaction is subject to a discount, or different portions of a transaction are subject to different discounts. Therefore, the issuer/remote computing entity 101 uses transaction data to identify a discount to be applied to the transaction as shown at 607. It should be understood that in some instances, discounts may be product-specific, and so multiple discounts may be applied to a single transaction where different products/services are purchased in a single transaction. The issuer/remote computing entity 101 uses portions of the transaction data, including, for example, the purchaser identifier, the merchant identifier, the products purchased, the date/time of the transaction, and/or the like to identify all discounts that may be applicable to the transaction. Where a purchaser has requested a fuel code that is useable at a particular merchant by only that purchaser, the fuel code and associated discount may be stored in the look-up table with other available discounts such that the issuer/remote computing entity 101 can easily identify the fuel code discounts, along with other applicable discounts for a transaction. Where multiple, alternative discounts may be applicable for a single transaction (e.g., a purchaser-specific discount may specify a first discount amount for a particular product purchased and a merchant-specific discount may specify a second, different discount amount for the particular product purchased), the issuer/remote computing entity 101 applies rule-based processing to select a single discount for the transaction. For example, the issuer/remote computing entity 101 may select the largest discount (for the lowest overall transaction cost to the purchaser) for the transaction. Once the discount is identified, the issuer/remote computing entity 101 determines a second transaction value (equal to the first transaction value, minus the discount; also referred to as the discounted transaction value) of the transaction, and applies the second transaction value against the purchaser's payment account as shown at 608. This may involve deducting the second transaction value from a financial account associated with the purchaser or deducting the second transaction value of the transaction from a credit account of the purchaser. For clarity, the second transaction value is less than the first transaction value that is paid to the merchant.

The issuer/remote computing entity 101 also calculates a cost value to at least partially offset the value of the discount afforded to the purchaser as shown at 609. The cost value may be calculated based at least in part on data stored in the merchant account associated with the merchant. Such data may define an agreed amount of discount to be paid by the merchant. This agreed amount may consider the cost of the discount and the cost of fees paid to the payment network, so that the merchant is not receiving a transaction value that is reduced by the entire amount of the payment network fees and the discount value. In some embodiments, the issuer may request that the merchant pay the cost value in real-time, shortly after each transaction is settled. In other embodiments, the issuer may request that the merchant pay the cost value for a plurality of transactions simultaneously, at designated payment times (e.g., twice/week).

Regardless of the frequency that payment of the cost value is requested, the payment is performed using a transfer of funds along a second payment channel that is outside of the payment network 160, as shown at 610. Funds transfer may be performed, as an example, by causing a financial account to transfer funds between accounts (e.g., between an account associated with a merchant to an account associated with an issuer). The second payment channel passes through network 150. In some instances, the issuer sends a payment request to the merchant system 103 to complete payment using the second payment channel (e.g., a direct payment from a financial account of the merchant to a financial account of the issuer). In other instances, the issuer may owe the merchant funds for other services performed and/or for other transactions settled on behalf of the merchant. In such instances, payment of the cost amount by the merchant entails deducting the cost amount from a total amount of funds owned by the issuer to the merchant.

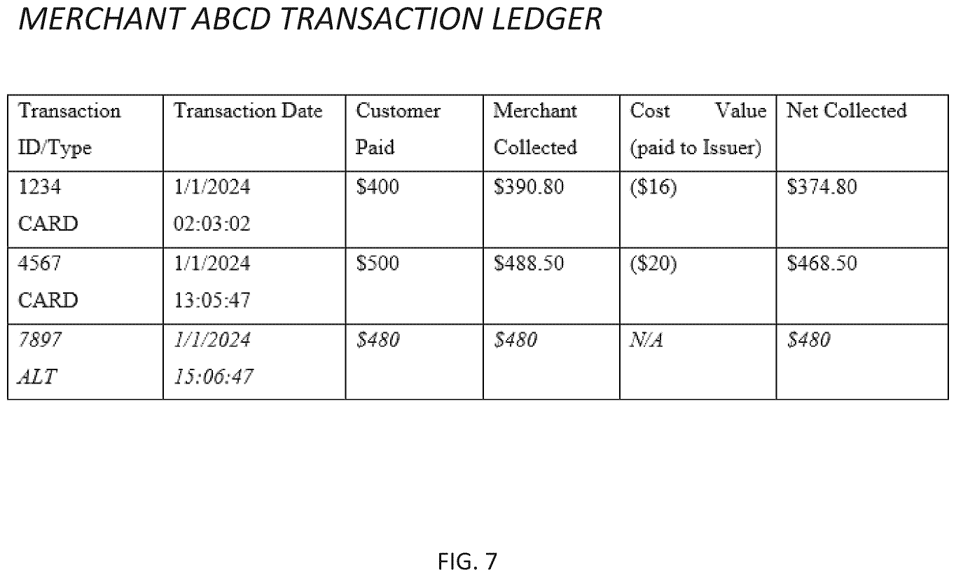

At 611, the issuer/remote computing entity 101 generates a user interface comprising a ledger of transactions for the merchant that utilize the issuer/remote computing entity 101. An example graphical user interface is shown in FIG. 7, although it should be understood that certain functions of graphical user interfaces are not reflected in the example of FIG. 7. The transactions reflected in the ledger may comprise the transactions that utilize the multi-channel payment settlement process discussed herein. In some embodiments, the transactions reflected in the ledger additionally comprise other transactions settled at least in part by the issuer/remote computing entity 101 on behalf of the merchant. The ledger distinguishes between various transaction types. For example, merchant-purchaser transactions that utilize the multi-channel settlement process discussed herein (referred to as multi-channel purchase transactions) may be presented with a first format (e.g., a first text color, a first highlight color, a first text font, and/or the like). In some embodiments, the ledger presents the first transaction value, the second transaction value, fees payable to the payment network 160, and/or cost amounts (payable to the issuer/remote computing entity 101) within the ledger. As discussed above, the fees payable to the payment network 160 and/or cost amounts may be calculated or paid significantly later than the multi-channel purchase transaction is completed between the merchant and purchaser. Therefore, the issuer/remote computing entity 101 may show certain of these amounts as “Pending” or with another designation until the fees/costs are paid and until the remote computing entity 101 locates transaction records for the payment of the fees/costs and matches those transaction records with the multi-channel purchase transaction. In some embodiments, data of the fees paid to the payment network 160 may be retrieved (e.g., in real-time when generating the graphical user interface showing the ledger) from the payment network 160 (e.g., using an API). In other embodiments, data of the fees paid to the payment network 160 may be provided to the issuer from the payment network 160 and may be displayed within the graphical user interface of the ledger only once the data of the fees paid to the payment network 160 are stored in memory of the remote computing entity 101 and matches with a record of the multi-channel purchase transaction. In certain embodiments, the cost data for the multi-channel purchase transaction, as well as the status of whether the cost amount has been paid, is stored in memory of the remote computing entity 101. As discussed above, the cost data may comprise a transaction identifier that matches a transaction identifier for the multi-channel purchase transaction, and so displaying the cost amount within the graphical user interface of the ledger comprises retrieving the cost data from a database, using the transaction data as a reference to identify the proper data.

Merchant-purchaser transactions using a different settlement process (referred to herein as alternative purchase transactions) may be displayed using a second format (e.g., a second text color, a second highlight color, a second text font, and/or the like). To the extent the remote computing entity 101 stores and/or has access to retrieve data of ancillary transactions relating to these alternative purchase transactions (e.g., data of fees/costs paid for settling these transactions), the graphical user interface can display data of these ancillary transactions within the displayed ledger. FIG. 7 shows a simple example of a graphical user interface including multi-channel transactions as discussed herein (referred to as “CARD” transactions in the example interface) together with alternative transactions (referred to as “ALT” transactions in the example interface).

The graphical user interface may provide various filtering options, such as to display only cost data-related transactions (i.e., transactions whereby the merchant pays the issuer the cost amount). This filter may keep the same number of line-item records within the ledger, but removes data of the multi-channel purchase transaction. However, where alternative purchase transactions are shown, those alternative purchase transactions may be removed from the displayed ledger. The graphical user interface may provide other filter options, such as time-based filters, purchaser-based filters, and/or the like. In some embodiments, the graphical user interface may provide other display options, such as to separate out fees, costs, and multi-channel purchase transactions into separate line items. When selected, the graphical user interface may update the displayed data to reorganize the line items. Each line item may include a transaction identifier that enables a viewer to easily identify how these line items are related to one another. In some embodiments, the formatting of the displayed text may change, for example, to distinguish between transaction types (e.g., fees paid to the payment network, cost amount paid to the issuer, fist transaction value collected from the purchaser, and/or the like, may each be characterized by different formatting within the displayed ledger).

Finally, an example transaction will now be described with example values. A purchaser may present a payment instrument at a fueling station to purchase 100 gallons of fuel, where the published price is $4/gallon. Because the purchaser has an account with the issuer, the purchaser is aware that he/she receives a discount of 20 cents/per gallon, for a discounted price of $3.80/gallon. Therefore, the published total price of this transaction is $400, and the discounted value of this transaction is $380.

The merchant requests verification that the purchaser's payment account is authorized for this transaction by communicating with the issuer (as identified from payment data) using the payment network 160. Thereafter, the merchant completes the transaction, generates final transaction data including the total published price of $400 (and itemized data of the transaction) and send the transaction data using the payment network 160 to the issuer. There is a 2.3% fee payable to the payment network/issuer (the payment network and issuer collect portions of this fee prior to reimbursement reaching the merchant), calculated based on the first transaction value, and so the merchant receives a payment of $390.80 from the payment network (equal to $400 less $9.20 in fees) through the first payment channel. At this stage, the merchant has received $390.80 for the transaction, the payment network and issuer split $9.20 in fees for the transaction. The issuer has paid $400, less the fees held by the issuer for the transaction.

The issuer receives the final transaction data, reflecting the $400 first transaction value. The issuer/remote computing entity 101 uses the transaction data to identify the appropriate discount that is applicable to the transaction. If multiple discounts are available, the issuer/remote computing entity 101 selects a single discount for application for the transaction. in this case, the issuer/remote computing entity 101 identifies the 20 cent/gallon discount. The issuer charges the purchaser the discounted second transaction value of $380. As will be understood at this point, the purchaser account is never charged the first transaction value (the undiscounted transaction value calculated based on the published/publicly advertised price of goods/services), and therefore the purchaser does not need to maintain a complicated ledger to ascertain the discounted, second transaction value actually paid for the transaction.

The issuer/remote computing entity 101 calculates the cost value for the transaction. In this example, the issuer/remote computing entity 101 agrees to reimburse the merchant for a portion of the payment network fees, equal to 1% of the first transaction value. The merchant is otherwise responsible for the entire discount. Since the entire discount for this transaction was $20, and the issuer has agreed to reimburse the merchant for $4 (1% of the first transaction value), the cost value is equal to $16. This cost value is owed by the merchant to the issuer. Payment for the cost value is passed through a second payment channel, outside of the payment network 160 (and passing through network 150). As discussed above, payment of the cost value may be paid by the merchant to the issuer, or the value of the cost value may be deducted from an amount owed by the issuer to the merchant. In certain embodiments, the cost value may be paid in real-time (shortly after determining the cost value) from the merchant to the issuer. In other embodiments, the cost value may be calculated, and the cost value for multiple transactions may be summed before the merchant pays the issuer using the second payment channel. In yet other embodiments, the cost value for one or more transactions may be determined and may be deduced from an amount payable by the issuer to the merchant (e.g., for reimbursement of other, alternative transactions).

After the payment of the cost value has been completed on the second payment channel, the merchant has received a net value of $374.80 for the transaction. Because the cost value is paid using the second payment channel and includes a transaction identifier that matches the original transaction identifier of the transaction with the purchaser, a ledger visible to the merchant explicitly shows the amount received from the transaction with the purchaser (a net inflow of funds to the merchant from the first payment channel) and the amount paid to settle the transaction (a net outflow of funds from the merchant from the second payment channel).

### Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A multi payment channel electronic transaction settlement system comprising memory and one or more processors configured for:
receiving, using the one or more processors, first transaction data transmitted from a merchant using a first payment channel of a payment network, wherein the first transaction data comprises a merchant identifier, a purchaser identifier, and a first transaction value for a transaction between the merchant and a purchaser;
deducting, using the one or more processors, a second transaction value from an account identified by the purchaser identifier, wherein the second transaction value is less than the first transaction value;
generating, using the one or more processors, cost data comprising an amount owed by the merchant to satisfy at least a portion of a difference between the second transaction value and the first transaction value;
transmitting, through a second payment channel separate from the payment network, at least a portion of the cost data to the merchant; and
causing transfer of funds through the second payment channel to settle the amount owed by the merchant.

2. The multi payment channel electronic transaction settlement system of claim 1, wherein receiving the first transaction data transmitted from the merchant and through the first payment channel further comprises causing transfer of funds using the first payment channel to the merchant.

3. The multi payment channel electronic transaction settlement system of claim 1, wherein the transfer of funds through the second payment channel comprises transferring funds having a value calculated based in part on the amount owed by the merchant.

4. The multi payment channel electronic transaction settlement system of claim 1, wherein receiving the first transaction data comprises:
receiving a transaction authorization request for a standard transaction value;
verifying the account identified by the purchaser identifier can satisfy the standard transaction value; and
transmitting, a transaction authorization to the merchant to enable the merchant to generate the first transaction data.

5. The multi payment channel electronic transaction settlement system of claim 4, wherein the transaction authorization request is received before the first transaction value is determined by the merchant.

6. The multi payment channel electronic transaction settlement system of claim 1, wherein at least a portion of the first transaction data is retrieved by a point-of-sale terminal at the merchant from a physical card.

7. The multi payment channel electronic transaction settlement system of claim 1, wherein the one or more processors are further configured for determining the second transaction value at least in part by accessing a reference table providing a discount for a purchase between the merchant and the purchaser.

8. A method for electronic transaction settlement using multiple payment channels, the method comprising:
receiving, using one or more processors, first transaction data transmitted from a merchant using a first payment channel of a payment network, wherein the first transaction data comprises a merchant identifier, a purchaser identifier, and a first transaction value for a transaction between the merchant and a purchaser;
deducting, using the one or more processors, a second transaction value from an account identified by the purchaser identifier, wherein the second transaction value is less than the first transaction value;
generating, using the one or more processors, cost data comprising an amount owed by the merchant to satisfy at least a portion of a difference between the second transaction value and the first transaction value;
transmitting, through a second payment channel separate from the payment network, at least a portion of the cost data to the merchant; and
causing transfer of funds through the second payment channel to settle the amount owed by the merchant.

9. The method for electronic transaction settlement using multiple payment channels of claim 8, wherein receiving the first transaction data transmitted from the merchant and through the first payment channel further comprises causing transfer of funds using the first payment channel to the merchant.

10. The method for electronic transaction settlement using multiple payment channels of claim 8, wherein the transfer of funds through the second payment channel comprises transferring funds having a value calculated based in part on the amount owed by the merchant.

11. The method for electronic transaction settlement using multiple payment channels of claim 8, wherein receiving the first transaction data comprises:
receiving a transaction authorization request for a standard transaction value;
verifying the account identified by the purchaser identifier can satisfy the standard transaction value; and
transmitting, a transaction authorization to the merchant to enable the merchant to generate the first transaction data.

12. The method for electronic transaction settlement using multiple payment channels of claim 11, wherein the transaction authorization request is received before the first transaction value is determined by the merchant.

13. The method for electronic transaction settlement using multiple payment channels of claim 8, wherein at least a portion of the first transaction data is retrieved by a point-of-sale terminal at the merchant from a physical card.

14. The method for electronic transaction settlement using multiple payment channels of claim 8, further comprising determining the second transaction value at least in part by accessing a reference table providing a discount for a purchase between the merchant and the purchaser.

15. A computer program product comprising a non-transitory computer readable medium having computer program instructions stored therein, the computer program instructions, when executed by a processor, cause the processor to:
receive first transaction data transmitted from a merchant using a first payment channel of a payment network, wherein the first transaction data comprises a merchant identifier, a purchaser identifier, and a first transaction value for a transaction between the merchant and a purchaser;
deduct a second transaction value from an account identified by the purchaser identifier, wherein the second transaction value is less than the first transaction value;
generate cost data comprising an amount owed by the merchant to satisfy at least a portion of a difference between the second transaction value and the first transaction value;
transmit through a second payment channel separate from the payment network, at least a portion of the cost data to the merchant; and
cause transfer of funds through the second payment channel to settle the amount owed by the merchant.

16. The computer program product of claim 15, wherein receiving the first transaction data transmitted from the merchant and through the first payment channel further comprises causing transfer of funds using the first payment channel to the merchant.

17. The computer program product of claim 15, wherein the transfer of funds through the second payment channel comprises transferring funds having a value calculated based in part on the amount owed by the merchant.

18. The computer program product of claim 15, wherein receiving the first transaction data comprises:
receiving a transaction authorization request for a standard transaction value;
verifying the account identified by the purchaser identifier can satisfy the standard transaction value; and
transmitting, a transaction authorization to the merchant to enable the merchant to generate the first transaction data.

19. The computer program product of claim 18, wherein the transaction authorization request is received before the first transaction value is determined by the merchant.

20. The computer program product of claim 15, wherein at least a portion of the first transaction data is retrieved by a point-of-sale terminal at the merchant from a physical card.

21. The computer program product of claim 15, wherein the computer program instructions, when executed by a processor, cause the processor to additionally:
determine the second transaction value at least in part by accessing a reference table providing a discount for a purchase between the merchant and the purchaser.
